(19) United States
(12) Patent Application Publication
(10) Pub. No.: US 2009/0076904 A1
(43) Pub. Date: Mar. 19, 2009

(54) Embedding digital values for digital exchange

(76) Inventor: Frank David Serena, Ridgecrest, CA (US)

Correspondence Address: MCNEELY BODENDORF LLP, P.O. BOX 34175, WASHINGTON, DC, 20043, US

(21) Appl. No.: 11/898,887

(22) Filed: Sep. 17, 2007

(51) Int. Cl. G06Q 30/00; G06F 17/30

(52) U.S. Cl. 705/14

(57) ABSTRACT

A system and methods are provided for the coupling of a digital value, credit, or cash with advertisements. Advertisements may include any sponsored content for presentation to a user. The advertisements may be placed with other content for presentation to a user. As the advertisements are presented to a user, the user accumulates the value, credit, or digital cash associated with the advertisements, which may be used to access or purchase additional content or services.

### TECHNICAL FIELD

The following description relates generally to electronic advertising, and in particular to coupling ad values to advertisements that may be redeemed to purchase content and services.

### BACKGROUND

Generally, advertising is a paid, one-way communication through a medium in which the sponsor is identified and the message is controlled. Variations of advertising include publicity, public relations, product placement, sponsorship, and sales promotion. Many different mediums are used to deliver these communications, including, for example, television, radio, movies, magazines, newspapers, the Internet, and billboards. Typically, access to the medium to place an advertisement is sold to an advertiser or sponsor.

Advertisements are usually placed anywhere that may easily and/or frequently accessed by an audience. For example, advertisements may be seen in many public areas, such as on the seats of grocery carts, the walls of an airport walkway, and the sides of buses. Advertisements also may be heard in telephone hold messages and in-store public address systems.

Advertisers are predominantly, but not exclusively, for-profit sponsors that seek to increase demand for their products or services through placement of their advertisements. The advertising industry is large and growing. Therefore, new means of advertising are continually sought to provide new and better access to advertisements.

### SUMMARY

In one general aspect, a content provider system to provide content to a user device over a communications path includes: an advertising system to provide advertising content from a sponsor; an ad value system to provide one or more ad values associated with presenting advertising content to a user and which may be redeemed to purchase content; a processing device to combine the advertising content with the one or more ad values; and an interface between the processor and the communications path to transmit the combined ad value and advertising content to a user device for presentation to a user.

The interface may be configured to receive a user selection for content having an associated price and to receive a user payment including the one or more ad values accumulated from presentation of associated advertising content to a user to purchase the content indicated by the user selection, and the processor is configured to process the payment for the price and provide the indicated content to the interface for transmission to the user device in response to successfully processing the credit. The processor may be configured to combine the ad value to the advertising content as a watermark.

The ad value may be digital cash. The ad value may include an associated time limit after which the ad value expires. The ad value also may be specified for a domain and redeemed only for content corresponding to the domain. The ad value also may be a general ad value provided to more than one user device.

In another general aspect, a user device to communicate with one or more content providers over a communications path includes: an interface to communicate with the communication path, to receive content from the content provider, and to receive combined advertising content and ad values; an interleaver to insert the advertising content in the content provider content for presentation to a user; an ad value decoder to credit a user with the ad value associated with the inserted advertising content.

The content received from the content provider may include one of temporal, spatial, or geometric interleaving cues and the interleaver inserts the advertising content according to the cues.

The ad value may be digital cash.

The user device also may include a bank to store the credit associated with ad values accumulated from presenting advertising content. The user device also may include a user interface to select content from the content provider having an associated price, wherein the interface is configured to send the decoded ad values to the content provider commensurate with the price and receive the selected content for presentation to a user.

In yet another general aspect a method of providing content from a content provider to a user device over a communications path includes: receiving advertising content from a sponsor; determining one or more ad values associated with presenting the advertising content to a user that may be redeemed to purchase content or services; combining the advertising content with the one or more ad values; and transmitting the combined ad value and advertising content to a user device for presentation to a user.

The method also may include receiving a user selection for content or a service having an associated price from the user device; receiving a user payment from the user device including the one or more ad values accumulated from presentation of associated advertising content to a user to purchase of the content or service indicated by the user selection; processing the payment for the price; and providing the indicated content or service to the user device in response to successfully processing the payment.

The method may include transmitting and receiving digital cash. The method also may include transmitting a general ad value provided to more than one user device and receiving the general ad value and a user identification. Combining the ad value with the advertising content may further comprise adding the ad value to the advertising content as a digital watermark. Determining an ad value may further comprise an ad value specified for a domain that may be redeemed only for content corresponding to the domain.

In yet another general aspect, a method for compensating a user for the presentation of advertising content transmitted to a user device over a communications path includes: receiving content from the content provider, receiving combined advertising content and ad values; inserting the advertising content in the content provider content; presenting the advertising content to the user; and crediting a user with the ad value associated with the presented advertising content.

Inserting the advertising content may include inserting the advertising content according to one of temporal, spatial, or geometric interleaving cues provided in the received content provider content. Receiving the combined advertising content and ad values includes receiving advertising content embedded with digital cash. Receiving the combined advertising content and ad values also may include receiving advertising content embedded with a general ad value provide to more than one user.

The method may include storing the credit associated with ad values accumulated from presenting advertising content. The method also may include selecting a content or service from the content provider having an associated price, transmitting the credited ad values to the content provider commensurate with the price; and receiving the selected content for presentation to a user or providing the service.

Other features will be apparent from the description, the drawings, and the claims.

### DESCRIPTION OF DRAWINGS

FIG. 1 is an exemplary block diagram of a system for coupling a digital value with advertising content.

FIG. 2 is an exemplary flow chart of a process for use in the system of FIG. 1.

FIG. 3 shows an exemplary block diagram of a user device.

Like reference symbols in the various drawings indicate like elements.

### DETAILED DESCRIPTION

The following description provides for the coupling of a digital value, credit, or cash with advertisements. Advertisements may include any sponsored content for presentation to a user. The advertisements may be placed with other content for presentation to a user. As the advertisements are presented to a user, the user accumulates the value, credit, or digital cash associated with the advertisements, which may be used to access or purchase additional content and services, as described in greater detail below.

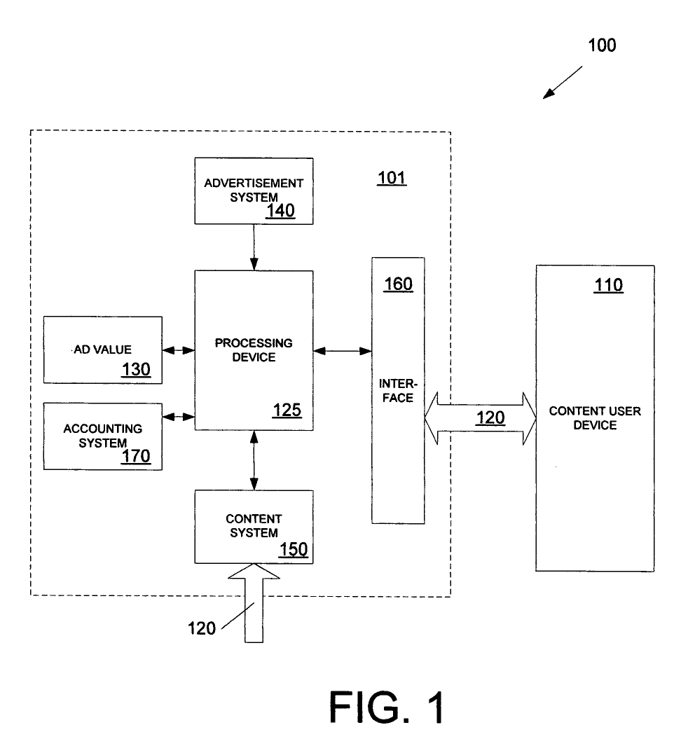

FIG. 1 shows an example of a system 100 to couple a medium of exchange, a digital value, a credit, or cash with advertisements that are presented to a user. The system 100 includes a content provider 101, a user device 110, and one or more communications paths 120 between the content provider 101 and the user device 110. The content provider 101 may include one or more processing devices 125, an advertisement system 130, an ad value system 140, a content system 150, a communications interface 160, and an external accounting system 170.

The content provider 101 may be implemented using any device, system, or combination thereof that provides electronic content selected by a user to a user device 110 for presentation to a user. The content may be provided, broadcast, communicated, and/or transmitted to the user device 110 using a communications path 120. For example, digital content also may be downloaded or streamed to a user device 110 either live or on-demand. The content may be digital or analog. The content also may be linear, non-linear, or combination of the two. Examples of types of content provided to a user include video, audio, text/characters, graphics, images, animations, interactive content, multimedia content, code/software/applications, web content, and combinations thereof. Examples of content include TV programs, music, books, games, software, and newspapers/periodicals.

The content provided to the user device 110 also may be a partial file or partitioned content. For example, the content may be a segment, such as a DVB-H (Digital Video Broadcasting-Handheld), a DMB (Digital Multimedia Broadcasting), a MediaFLO, a TV, a switched digital video (SDV), radio or other IPTV programming content up to a commercial break or other cue. The content may be partitioned for any number of reasons, such as, for example, controlling the flow of data, economics, system requirements or limitations, or to maintain the logical relation of the transmitted content.

The content provider 101 may include one or more devices, such as, for example, storage devices, processors, components, receivers, user interfaces, transmitters and/or interfaces used to provide, transmit, or communicate the content to a user device 110 over the one or more communications paths 120. Although shown as a single block in FIG. 1, one skilled in the art will appreciate that the content provider 101 may be a geographically distributed and/or networked system including multiple content, advertisement, ad value systems, and processing devices, in addition to the necessary hardware and infrastructure used to transmit and receive advertisements, content, and data over the communications paths 120. Examples of content providers include network, cable, and satellite TV providers, broadcast, HD, and satellite radio providers, Internet ISPs, websites, and other content distribution mechanisms.

The user device 110 receives the content from the content provider 101 and facilitates presentation of the content to the user. Although shown as a single block in FIG. 1, it will be appreciated that the user device 110 may be a single device or a collection of devices and peripherals used to receive, process, format, store, select, and/or present content received from the content provider 101. The user device 110 may include one or more of a processor, a storage device, an interface for communication with the communications paths 120, a user interface, a display, a microphone, a speaker, and a headset. Some examples of a user devices 110 include, a set top box, a DVR, a cable box, a satellite TV box, a PDA, an MP3/audio player, a audio/video player, a computer/laptop, a mobile phone, and a game console. An example of a user device 110 is described in greater detail below.

The communications paths 120 may be a single pipe or multiple pipes to provide communication between the content provider 101 and the user device 110. The communications paths 120 may be used to provide, among other things, data, content, and advertisements from the content provider 101 to the user device 110. The communications paths 120 also may be used to provide, among other things, data, content selections, purchases, ad values, credits, or spent digital cash from the user device 110 to the content provider 101. The communications paths 120 may be configured to send, transmit, carry, and receive signals (e.g., electrical, electromagnetic, or optical) that convey or carry data streams representing various types of analog and/or digital data. For example, the communications paths 120 may be implemented using various communications media and one or more networks comprising one or more network devices (e.g., interfaces, servers, routers, gateways, bridges, switches, hubs, repeaters, and storage devices). The one or more networks may include a LAN, a WAN, a plain old telephone service (POTS) network, a passive optical network (PON), an active optical network (AON), a digital subscriber line (DSL) network, an integrated services digital network (ISDN), a synchronous optical network (SONNET), the Internet, hybrid networks, or a combination of two or more of these networks. In addition, the communications paths 120 may include one or more wireless links (e.g., cellular, mobile, GSM, TDMA, CDMA, and satellite) that transmit and receive electromagnetic signals, such as, for example, radio frequency, infrared, and microwave signals, to convey data signals and information.

The digital advertisement system 130 provides sponsored advertisements for any type of media. The advertising content may include video, audio, text/characters/symbols, images, animations, interactivity (e.g., links, menus, thumbnails), multimedia, and web content. The advertisement may promote a product, a service, an event, a property, a company, a sponsor, or a position to attract or increase interest in something. The advertisement system 130 may promote one or more related or unrelated entities. The advertisements may be of a single or multiple data types. The advertisement system 130 may include one or more devices, such as, for example, storage devices, processors, servers, components, receivers, user interfaces, transmitters and/or interfaces necessary to provide, transmit, or communicate the advertisements to a user device 110 over the one or more communications paths 120. The advertisements may be provided by the content provider 101 and/or supplied from third party sponsors. The advertisement system 140 may store advertisements received from sponsors of the content and/or accept or retrieve advertisements from third parties and other sources.

The content provider 101 may include an ad value system 140 to assign values to the advertisements. The ad value is an amount or indication of monetary worth or other medium of exchange that may be redeemed by a user to purchase content and/or services. The ad value may be a number, an amount, a symbol or indication of value, a credit, or digital cash. The ad values may be determined based upon one or more factors, such as, for example, the source of the advertisement, the type of advertisement, the size or length of advertisement, when the advertisement is transmitted or presented, what content the advertisement is presented with or during, the content of the advertisement, the stickiness of the advertisement, the content type of the advertisement, and whether the advertisement is partially presented or entirely presented to a user. Ad values may be static or dynamic. The static ad values may be stored in one or more devices. Static ad values may be stored using, for examples, files, databases, lookup tables, and other ways of organizing data for access. The ad values also may be determined by a processor based on a number of factors (e.g., such as those described above), according to a formula, and may be dynamic allowing the values to be changed and/or updated. The ad values may be determined by the content provider 101 or by an auction that allows sponsors to bid on amounts for the right to place their advertisements. The ad values may be presented to and/or redeemed from the content provider 101 to purchase content or service from the content provider 101. The ad value may be encrypted to prevent tampering with the value.

The ad values may be a unique or general value. For example, the ad value may correspond to unique value, such as digital cash that is sent to a single user device. In this example, the sponsor pays up front for a certain value that is unique, for example, in the way a dollar bill with a serial number is unique. The ad value is unique in the sense that the ad value has only been proffered to a single user therefore upon redemption there is only one such ad value. In addition, the ad value may have a time limit or expiration date for redemption such that advertisements paid for by the sponsor that are not viewed within a set time period or date have the associated ad values credited to the sponsor after expiration of the time period.

The ad values also may be implemented using general ad values that are sent or broadcast to more than one user device. In this case, when the ad value is redeemed by the user, the ad value is associated with an authenticated unique user ID to ensure the value is properly redeemed and/or to prevent fraud. For example, a unique ID associated with the user that is presented an advertisement (e.g., an ID associated with a user account or an ID associated with the user device 110, such as an assigned network address with additional device specific serial numbers) may be appended by the user device 110 to the ad value when the ad value is presented for redemption or purchase. The content provider may determine that the ID is proper (e.g., the ID is registered to a user). In addition, the content provider may impose a limit on the crediting or redemption of the general ad value, such as a limit on the number times that a user may redeem the ad value or a time limit on when the ad value may be redeemed by the user.

When an advertisement is presented to a user (e.g., viewing, listening, and/or interacting with the advertisement), the ad value is credited to the user. The ad value may be banked or stored by the user device 110, the ad value may be stored in association with a user account of the content provider, and/or by a third party (e.g., an account system, a bank, or a payment service such as PayPal™). The ad value may be used to purchase content or services from the content provider 101. For example,-the ad value may be used to purchase access to one or more channels for a month, download a song as an MP3 file, download a game, or stream a movie file from a web server. The ad value may be generic or specific to a particular domain or several specified domains. For example, audio advertisements may be provided values that may be redeemed only for audio content. In another example, advertisements associated with a sponsor may be redeemed for content associated with the sponsor, such as a advertisement for an Apple computer resulting in credits to download a movie or a song from ITunes. Furthermore a satellite TV provider may stream ads and ad values that are redeemed to purchase access to certain content channels. The values also may be stored or banked in domain specific accounts.

The processing device 125 may be used to combine an advertisement with one or more ad values. The processing device may be implemented using a general-purpose or a special purpose computer, such as, for example, a processor, a digital signal processor (DSP), a microcomputer, a field programmable array (FPGA), a programmable logic unit (PLU) or a microprocessor capable of responding to and executing instructions in a defined manner. The processing device 125 may run one or more software applications including an ad value application to command and direct the processing device to combine advertisements and ad values. The processing device 125 also may run an application to facilitate user content selection or server application to receive data from a user device 110 including user selections, to process payments for content, and to provide selected to content to a user device 110, as explained in greater detail below. The software applications may include a computer program, a piece of code, an instruction, or some combination thereof, for independently or collectively instructing the processing device 125 to operate as desired. The processing device 125 also may access, store, manipulate, and create data in response to the applications.

The applications and data may be embodied permanently or temporarily in any type of machine, component, physical or virtual equipment, storage medium, or propagated signal wave capable of providing instructions or data to or being interpreted by the processing device. In particular, the applications or data may be stored by a storage medium or a memory including volatile and non-volatile memories (e.g., a read only memory (ROM), a random access memory (RAM), a flash memory, a floppy disk, a hard disk, a compact disk, a tape, a DROM, a flip-flop, a register, an SRAM, DRAM, PROM, EPROM, OPTROM, EEPROM, NOVRAM, or RAMBUS), such that if the memory is read or accessed by the processing device, the specified steps, processes, and/or instructions are performed and/or data is accessed or stored. The memory or unit may include an I/O interface, such that data and applications may be loaded and stored in the memory allowing the applications, programming, and data to be updated, changed, or augmented.

The processing device 125 receives or accesses an advertisement and ad values from the advertising system 130 and ad value system 140, and couples or combines the advertisement with one or more corresponding ad values using an encoding technique. In one implementation, the advertisement and ad value may simply be combined (e.g., a concatenation encoding). For example, the combined content may include an advertising data stream with an XML data containing the ad value appended. In another example, the ad value maybe inserted in a data packet containing the advertisement data, for example, in the header information of the advertisement data packet. The ad value also may be added using a technique, such as watermarking to produce the combined advertisement and ad value content that is transmitted to the user device 110 over a communications path 120. Watermarking the advertisement with the ad value modifies the advertisement data to allow for the subsequent recovery of embedded auxiliary ad value data. Using an invisible watermarking technique, the overall appearance of the advertisement may be maintained, for example, by using a discrete cosine transform (DCT) or other related transforms, least significant bit (LSB) substitution, correlation, spread-spectrum (e.g., CDMA) or wavelet encoding of the advertising data to encode the ad value such that when the advertisement is presented, the ad value is not apparent to the user. The ad value data so embedded is referred to as the watermark. The watermarked ad value may be encrypted or provided ready for redemption. Some exemplary techniques for watermarking are shown in U.S. Pat. Nos. 7,003,731, 6,996,249, 7,024,016, 6,771,794, and 6,332,194, which are hereby incorporated by reference in their entirety.

In yet another technique, the advertisement and ad value may be combined using an encryption technique to provide a more secure system that is resistant to tampering. The ad value may remain encrypted until the advertisement is presented to a user at which time the ad value is decrypted and made available to the system. For example, a message that includes the ad value and the advertisement may be encrypted together.

The processing device 125 also may receive requests for content from the user device 110. The content may be stored by a content system 150. The content system 150 provides one or more types of content. For example, the content system may include storage for one or more media and/or content types that may be provided to the user and any necessary hardware and software to facilitate content retrieval and transmission on the communication paths 120. The content provided by the content system also may be provided or obtained from external or third party sources by a communications path 120. For example, the content may be obtained from a web server on the Internet (e.g., as online music store such as ITunes) or from a TV content source (e.g. Home Box Office). For example, the user device 110 may select programming for viewing, network to connect, music to download, a web page to be displayed, RSS feed to be accessed, a game to be downloaded or played. The processing device 125 may determine the location of the content in the content system 150 and provide the content to the interface 160 for transmitting to the user device 110. The processing device 125 also may determine if there is a charge associated with the content and receive payment for the content.

The I/O interface 160 may be provided to exchange data and signals between the content provider 101 and the user device 110. The interface 160 may include two or more interfaces, including interfaces for different types of hardware and for different types of communications media and protocols to translate information into a format that may be used by the processing device. Similarly, the interface 160 may translate data/information received from the processing device 125 to a format that may be provided, broadcast, transmitted, or communicated via a communications path 120. The interface 160 allows the processing device 125 to send and receive (or cause to be sent or received) information using the communications paths 120.

The user device 110 may select and receive content for presentation to a viewer. The user device 110 also receives advertisements that have a combined ad value. The user device 110 may buffer, cache, and/or store the received content and/or the received combined advertisement and ad value. When the content is presented to the user, the advertisement may be combined with the content for presentation to the user. For example, a commercial may be inserted into a TV program; an advertisement, link, or thumbnail may be inserted into a web page; or an advertisement logo may be inserted on a 3D surface in a video game or virtual world.

The user device 110 may insert received advertisements to interleave the advertisement with content to be presented to a user. Interleaving may be temporal, spatial, or geometric. In one example, content received from the content provider 101 may be tagged with metadata, such as cues that specify where to interleave the advertisements with the content. The cues may be spatial, temporal, and geometric. The user device 110 may use the cues to interleave the content and the advertisements, or the user device 110 may use user specified criteria to direct interleaving of the content and advertisements. In this case, the metadata may be used as a suggested placement within the user specified interleaving criteria.

Temporal interleaving embeds interleaving cues between segments, portions, or partitions of the content. The cues specify where advertisements are inserted in a content data stream. To allow for latencies, a small time delay may be inserted to buffer or cache the content at the user device 110. Pre-fetching and playback of content may be used to produce seamlessly integrated temporal content. Spatial interleaving may be used to insert advertisements in 3-dimensional content. The advertisement is interleaved with the 3-dimensional world by using an interleaving cue to indicate where to place the advertisement on a surface of the 3-D content that is presented to a user, for example, a billboard or sign in a virtual game world. Geometrical interleaving specifies where in a web page, text document or other two dimensional environment to embed advertisements using geometric interleaving cues. Cues in a geometrical interleaving environment may include indicators of dimensions and/or positions where advertisements may be inserted or presented with content. For example, meta-tags, escape sequences or standard HTML-tags may be used as the cues that tell the browser or other presentation application where to insert the advertisement in the content (e.g., a webpage or document).

Interleaving may be performed by hardware, software, and/or a combination of the two in the user device 10. For example, interleaving of a received advertisement may be performed by a browser operating on the user device 110. Interleaving may occur for example with standard video files such as MPEG-4, Motion JPEG 2000 or AVI files wherein the files are partitioned into distinct segments wherein commercial content can be inserted. Some file formats even provide for meta-data that is synchronized with the display of the frames. This meta-data can be used by the interleaving system to determine where and when to place advertising in the data stream. In the event that a video format does not support meta-data directly the interleaving cues can be invisibly watermarked in the content stream. To meet real-time timelines for seamless insertion of advertising the interleaving system operates with hardware and software decoders of the video formats to insert advertising at specified times and geometries.

The combined advertisement and ad value is received by the user device 110 and may be cached, buffered, stored or provided to an interleaving/viewing subsystem for interleaving with the content received from the content provider 101. The content may be received and presented, buffered and presented, or stored and accessed for playback. As the content is presented, the interleaving subsystem inserts the advertising content according to the cues for the content.

When the advertisement is presented to a user, the user device 110 banks an ad value associated with the presented advertisement. A user interface may provide a user with the totals of accumulated credit or digital cash. For example, a menu, a screen, a display, or window or portion thereof may show the user their accumulated credit for advertisements that have been presented. The total credit may be presented and/or the credit for each specified domain may be presented. A user interface also may present the price or cost associated with content that may be purchased by the user. The cost may be the actual cost of the content or it may reflect a cost for the particular user that has been adjusted by the amount of credit the user has accumulated in their account from presented advertisements.

When a user purchases content using their accumulated credit, their account is adjusted to reflect the credit spent. The amount corresponding to the price and content selection is provided to the content provider 101 from the user device 110. If digital cash or encrypted ad values are being used, the content provider 101 may determine the authenticity of the credit presented by the user before approving the users purchase. Once authenticated or verified, the content system provides the selected content to the user device 110. The amount presented to purchase the content also may be supplemented using real credit or other payment or charged to a user account.

The content provided to a user may include a full suite of digital rights management (DRM) techniques to maintain intellectual property rights associated with the content. DRM of the content provided to the user may be preserved by conveying data and use conditions or rules that are consistent with the DRM information. For example, the user device 110 and/or content provider 101 may run a DRM enabled operating system and/or applications through the content provider 101 and/or on the user device 110. Pricing information may be embedded in DRM, and the DRM may be modified after payment to permit a specified use by the user device 110 (e.g., presenting the content a number of times or allowing access to the content for a time period).

The ad value may be protected to ensure that the value is not tampered with and to ensure that the money is not spent twice. To protect the ad value, a cryptographic protocol may be used including key agreement or establishment, entity authentication, symmetric encryption and message authentication material construction, and/or secured application-level data transport. Redundancy and hash functions also may be used to supplement protection in addition to other tamper identifying techniques, such as fingerprinting.

Any number of digital cash protocols also may be used to provide unique ad values embedded with the advertisements. Some exemplary implementations of digital cash are provided in U.S. Pat. Nos. 4,987,593 and 4,914,698, which are hereby incorporated by reference, where the digital cash can be spent only once or the originating account is revealed. For example, once an ad value is created, a blind signature scheme may be run to obtain a signature on some random number used to identify a digital coin or cash amount. When the advertisement is presented to the user device 110, the ad value is decrypted and stored by the user device 110 with the signature. When the user purchases content, the user device sends the signature together with the random number to the content provider 101. The content provider 101 or a third party (e.g., a bank) verifies the signature. If the signature is valid, the content provides the selected content or modifies DRM of content provided to the user device 110. The content provider 101 also may redeem the digital cash from the sponsor or an electronic bank and/or update the sponsor's account for the amount spent. The content provider 101 or bank may verify the signature and store the random value in a database. If the content provider 101 or bank has never accepted the cash with the same random number before, the digital cash is determined to be valid.

In the case of a general ad value, the ad value is not unique in the sense that it is sent to more than one user device. The general ad value also may be decrypted and banked by the user device 110 after the advertisement is presented to a user. However, instead of submitting the random number as described above, the user device provides a unique identification, such as a user or user device ID that is submitted with or appended to the general ad value when the ad value is presented for redemption. The content provider receives the general ad value and identification and determines verifies the ad value. In this verification because the ad value is not unique, the system 100 may impose limits on redemption of the value. For example, the content provider 101 may limit the number of times a specific identification may present the general ad value for redemption. Time limits on redemption of general ad values also may be imposed.

The content provider 101 also may include an accounting system 170. Because the ad values may not be in one-to-one correspondence with real currency or dollars, the accounting system may be used to facilitate compensation between parties by translating redeemed ad values into a real flow of currency or dollars. The accounting system 170 may be used to determine and track credits and debits for the sponsors, the sponsored content, and the content provider accounts. The accounting system 170 may store data related to ad value redemption. For example, the accounting system may determine the ad value redeemed for each sponsor and determine a corresponding payment from the sponsor for the redeemed ad values. The payments may be determined according to the factors given above and/or various accounting formulas that take into account the number of times the advertisements were presented, the number of users the advertisements were presented to, percentage of advertisements viewed, and so on. If unique ad value such as digital cash is used, the accounting system may determine any amount of digital cash that was not redeemed and/or expired and credit the sponsor for the ad content. The accounting system also may determine if a percentage of the ad values are due to sources of the content to cover royalties or other compensation due for the right to provide the content.

To give one example, the content provider may be a cable TV company providing cable TV and Internet services. It may receive advertisements from sponsors for GM, Apple, and Discovery Channel. The cable TV company assigns ad values to each of the advertisements of 30, 20, and 10 respectively. The advertisements are provided to a user and viewed by the user of a set top device during the Super Bowl. The user may use the accumulated ad value of 60 to purchase a HBO movie channel for a month, as service the cable TV company normally charge $4. The accounting system of the cable TV provider determines that based on a premium time formula for the Super Bowl the value is factored by 0.05 to determine a real dollar value and that GM owes $3, Apple owes $2, and the Disney owes $1 to the cable TV provider. In addition, the cable TV provider owes 1 dollar to HBO for digital rights associated with the HBO content.

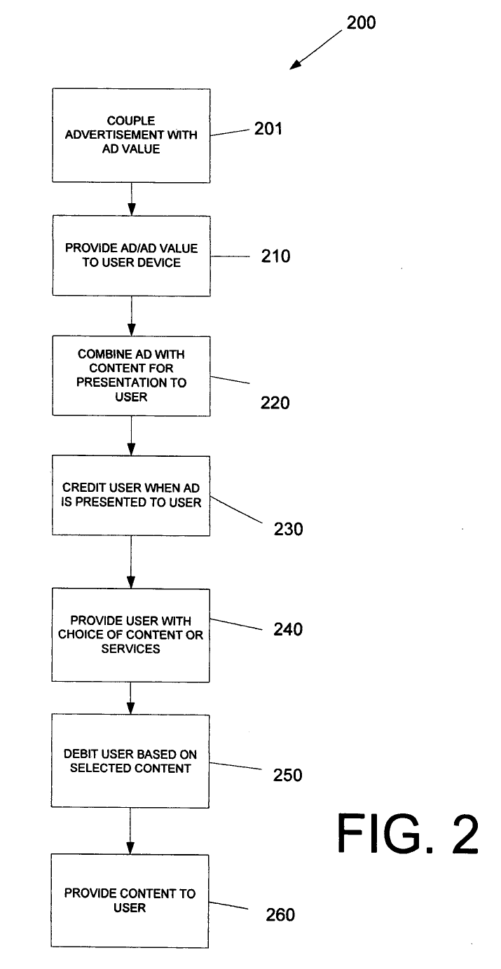

FIG. 2 shows a method 200 for use in the system of FIG. 1. According to the method, an advertisement or -sponsored content is coupled with one or more ad values (201). The ad value may be set by the sponsor and/or the content provider 101 based on a number of factors, such as those described above. The advertisement and corresponding ad value may be coupled in a number of ways including concatenation, watermarking, and encrypting. The ad value may be a number indicating the value of the advertisement when presented to a user of the system. The number may be or correspond to an actual dollar amount or a to a distinct type of credit for use within the system. The ad value also may be tagged for use only with a specified domain (e.g., a particular sponsor, product, content, and/or content type). In one embodiment, instead of a number, the ad value may be implemented using actual digital or e-cash. More than one value may be associated -with an advertisement. For example, an advertisement may include one value for presenting the entire advertisement and a second value for presenting a portion of or precis of an advertisement or different values for different domains of content.

The coupled advertisement and ad value are provided to a user (210) using any number of media including optical, electrical, and electromagnetic communications paths 120. The coupled advertisement and ad value may be provided to a user device 110 for presentation to a user. To facilitate presentation, the advertisement and ad value may be buffered and/or cached at the user device 110 for optimal timing, seamlessness, and presentation to user. A pool of advertisements and ad values may be stored or cached by the user device 110 for insertion into content. New advertisement and ad value content may be provided or updated as advertisements are presented to a user. Advertisements and ad values also may be stored at the user device 110 and may have a temporal or life of use component. New Advertisements and ad values may be provided periodically to the user device 110 and old advertisements deleted. Advertisements and ad values may be provided based on user criteria, demographics, user action/interaction/observation, or a combination thereof. Advertisements and ad values may be prioritized so that certain advertisements and ad values are inserted more or less frequently. Advertisements and ad values also may be encoded to be shown a specified number of times before being deleted from an advertisement and ad value pool or cache.

The advertisements are combined with or inserted in content for presentation to a user of the user device (220). Presentation may be visual, audible, interactive, and/or a multimedia combination of these. The advertisements may be combined or inserted by using any number of known techniques to interleave the advertisements with the content presented to the user, such as temporal, spatial, and geometric interleaving. Cues in the content may be used to direct interleaving or placement of the advertisements.

Before or during interleaving, the advertisements and ad values are decoded as a reciprocal of the encoding/inserting/embedding process to unlock or credit the ad value associated with the advertisement when the advertisement is presented to a user (230). Encrypted advertisements and ad values may be decoded prior to insertion whereas watermarking and concatenation may be decoded in parallel with or after insertion of the advertisement. Once the advertisement is viewed, the cash value associated with the advertisement is credited to the user. The credit may be banked at the user device, stored in association with a user account, and/or managed by a third party, such as a bank or payment service. Multiple cash values may be credited based on user interaction with the advertisement. For example, different values may be received based on viewing, playback, fast forwarding, or interaction with content, such as placing a cursor on thumbnail on advertisement content versus actually selecting the thumbnail associated with the content. The credit may be added to or supplemented by user cash or credit. Ad values also may be dynamic and changed, such as, for example, decreasing the ad value each time the advertisement is viewed. In addition, the credit may be domain specific, for example, the credit may only be redeemed for a specific content and/or content type. The domains may be a sponsor, a company, a product, a content provider, a content source and/or a type or format of media. The ad value also may specify multiple domains.

The user device also provides user with a selection of content or services for purchase by the user (240). The user may select content to be presented by the user device. Content may be free, based on a user subscription, or content may have an associated cost with presentation/DRM/use of the content. The user may be provided with a cost of selecting the content in any number of different ways. For example, menus listing content may be provided with a corresponding price or cost of presenting the content. The cost presented to the user or associated with the content may be automatically adjusted to reflect the credit accrued by the user. Of course, real money, cash, credit, or charges may be used to purchase content in addition to or in substitution of the ad values or credit accrued from presenting advertisements.

Once the user selects content, the user credit or accumulated ad value is debited (250). For example, if digital cash is used, the digital cash is provided to content provider 101 for redemption using a digital cash protocol. The content is then provided to the user (260).

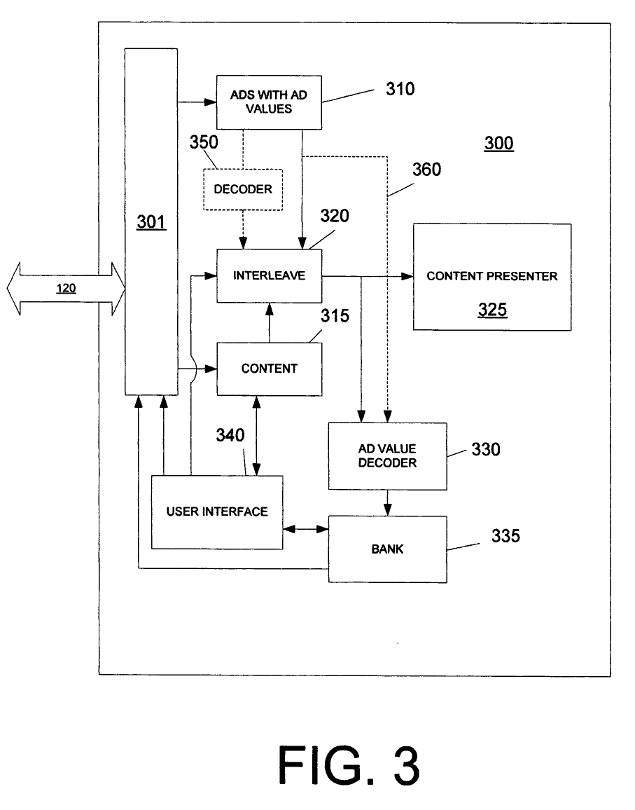

FIG. 3 shows an exemplary user device 300 for use in the system 100. The user device 300 includes an interface 301, an advertisement storage device 310, a content storage device 315, an interleaver 320, a content presentation device 325, a cash decoder 330, a bank 335, and a user interface 340.

The interface 301 exchanges data and signals using the communications path 120. The interface may include two or more interfaces, including interfaces for different types of hardware and for different types of communications media and protocols to translate information into a format that may be transmitted on and received from the communication path for use by the user device and its processing device. The interface allows the user to send data and signal to and receive data and signal from the content provider 101 including content, user selections for content, and advertisements with ad values.

The coupled advertisements and ad values received by the interface 301 are provided to an advertisement storage device 310. The advertisement storage device may be implemented as a buffer to allow for seamless temporal interleaving with content received from the content provider 101 for presentation to a user. The advertisement storage device also may be implemented as a storage medium or a memory including volatile and non-volatile memories (as defined above). For example, the advertisement storage medium may be a cache or high speed memory to store advertisements for playback with content. In addition, the storage medium may be part of the memory for the entire user device (e.g., a hard or flash drive) or receive advertisements stored by the main memory of the user device 300.

Similarly, the interface 301 also provides content received from the content provider 101 to a content storage device 315. The content storage device 315 may be implemented as a buffer to allow for seamless temporal interleaving of content with advertisements presented to a user. The content storage device 315 also may be implemented as a storage medium or a memory including volatile and non-volatile memories (as defined above). For example, the content storage device 315 may be a cache or high speed memory to store content for playback to a user. In addition, the content storage medium may be part of the main memory for the entire user device 300 (e.g., a hard or flash drive).

An interleaver 320 combines or inserts the advertisement into the content which is then provided to the content presentation device 325 for presentation to a user. The interleaver 320 may access content from the content storage device 315 and advertisements from the advertisement storage device 310. The interleaver 320 uses cues in the content to insert or combine advertisements with the content. The interleaver 320 may be implemented in hardware and/or software of the user device. For example, a browser application running on a processor of the user device 300 may perform the function of interleaving. The user interface 340 may provide data and commands to the interleaver 320. For example, the user interface 340 may indicate which content is to be presented. The user interface 340 also may indicate user preferences that are used in the selection of advertisements by the interleaver 320 to be inserted with the content.

The content presentation device 325 may include one or more devices that facilitate the presentation of content to a user, such as, for example, a display, a screen, a touch screen, a speaker, and a headset. The content presentation device 325 receives the combined content and advertisement for presentation to the user.

In the example shown in FIG. 3, the combined stream of content and interleaved advertisements are also provided to an ad value decoder 330. The ad value decoder 330 decodes the ad value, for example, a watermark, included with the interleaved advertisement that is presented to the user. If the ad value is in the clear, the ad value decoder 330 deposits the ad value in the bank 335. If the ad value is encrypted, the ad value decoder 330 decrypts the ad value and conveys the value to the bank 335. The ad value may be banked according to a corresponding domain of the ad value. In addition, if more than one ad value is included, the appropriate ad value is banked (e.g., presentation of the whole advertisement versus fast forwarding or partial playing of the advertisement). The ad value decoder 330 may be implemented in hardware and/or software of the user device 300.

The bank 335 may be implemented as a bank storage device or e-wallet to store the accumulated ad values earned from presentation of advertisements. The bank storage device may be implemented as a secure storage medium or a memory including volatile and non-volatile memories (as defined above) that is resistant to tampering. For example, the storage medium may be part of the memory for the entire user device 300 (e.g., a hard drive or flash drive). The bank 335 may store ad values according to a specific domains associated with the advertisements. The ad values may be accessed by the user interface 340 to provide an accounting of the accumulated and spent ad values and to aid in selection and payment for content. When content is purchased by the user, the ad value is sent to the content provider 101 for redemption and reconciliation.

The user interface 340 may include a number of devices and/or software for selecting content for presentation by the user device. The user interface 340 may include buttons, touch-screens, touchpad, keys, keypads, switches, knobs, dials, displays, speakers, microphones, keyboards, a mouse, joystick, game interface, and trackball. The user interface 340 also may include software, such as, browsers, media players, user interface applications, and game applications/software.

It is noted that the user device 300 is exemplary and many modifications can be made. For example, the content presentation device 325 may be an interface that communicates with an external or peripheral component that presents content, such as, for example, a display, a TV, a screen, a monitor, speakers, audio/video components (cable box, stereo, tuner, VCR, DVD player) or another computing device (e.g., a laptop, a computer, or a processor). In addition, the user device 300 shows presentation of the advertisement and decoding of the cash in parallel. However, other decoding arrangements or flow paths may be made. For example, if the advertisement packet and ad value are encrypted, a decrypting block 350 may be added to decrypt the packet before interleaving. In addition, decoding of the ad value may be performed before or in parallel with interleaving of the advertisement (e.g., as shown by dotted line 360 in FIG. 3). In addition, the user device 300 is shown as including a bank 335; however, the bank 335 may be implemented remotely, for example, with the content provider 101 as part of a user account, or with a third party, such as a bank or payment service. In this case, accumulated credits are provided from the decoder 330 to the interface 301 to be transmitted by the communications paths 120 to the appropriate entity for accounting and purchase of content. In addition, the user interface may be implemented separately from or in addition to the interface provided by the user device, such as a wireless or IR remote control or a game controller.

A system has been described that inserts sponsored content or advertisements in content that is presented to the user. The advertisements include associated ad values or digital cash embedded in the sponsored content to pay for content. An interleaving subsystem merges the content and advertisements in a manner specified by the user and/or the content provider 101. The interleaving subsystem initiates a digital cash protocol used to spend digital cash to purchase the content.

The provision of digital cash merged with sponsored content may be linked to an accounting system whereby sponsors pay for the digital cash to be merged. In one example, the digital cash results in an actual cash payment made from the sponsored content provider 101 to the content provider 101 upon redemption of the digital cash by the user. Payment also may be made in advance when the digital cash is merged with the sponsored content. The digital cash may include a built-in time limit for redemption so that advertisements that are not presented to a user within the time limit yield a credit to the account of the sponsored content provider 101. In addition, the expired digital cash cannot be used for commerce with content provider 101.

The system facilitates advertising customization by compensating the content provider 101 without requiring a specific advertisement to be presented with a specified content by ensuring that sufficient digital cash is available to purchase content. In addition, an accounting system may be used to track the credits and debits to sponsors, the sponsored content, and the content and/or service provider accounts. As a result, a viewer may customize the sponsored content presented while remunerating the content provider for digital rights associated with content in a highly efficient and automated manner.

The user simply selects the content and the system pays for the content in the background. A viewer may specify, either directly or through inferred historical viewing analysis what kind of advertisements are preferred. These settings may be stored and/or communicated to the content provider 101 to influence the sponsored content received by the user device. Stored settings in a user account and/or by the user device may determine what kind of advertisements are cached and displayed for a real time viewer selection of content. A user selects content, as described above. Advertisements meeting the viewer settings are accepted by the user device with their payload of digital cash/ad value and presented to the user. Once the advertisements are presented, the digital cash associated with the advertisement is released (e.g., via decryption of the digital cash) and spent (e.g., using a cryptographic payment protocol) on content from the content provider 101.

The digital cash may be unique and preserve all the cryptographic properties of the cash or general values with a unique id associated with a user may be supplied via cryptographic methods to insure that the digital cash is spent only once. The digital cash value redeemed by a user results in a credit in the content distribution system. The credit may be used to access content using conventional DRM. Alternatively, the credit may result in transmitting the content for interleaving and subsequent presentation to a user. Content prices and the incident value of the digital cash may vary as desired.

Using advertisement customization, the user may opt-out of viewing advertisements they find objectionable by paying for the content or viewing alternate advertisements (each having its own ad value) and accumulating credit with which to purchase the content. The user also may select advertisements based on digital cash value of the advertisement (e.g., only allowing high value advertisements that consume less time or space for the viewer). The sponsor may take the data generated by the accounting system to pay for only those advertisements that are actually viewed by the user. The accounting system between sponsor and content provider 101 may be used to facilitate this payment.

Of course a content provider 101 may be a reseller of the content (e.g., a TV broadcast network, Amazon Unboxed, or Apple iTunes) paying a royalty to the owner of the content. In either case, the accounting system may influence how prices are set for placement, internal redemption, and viewing of the advertisements. As a result, the user may customize their user experience without significant detriment to the existing business models of the sponsor and content provider 101. Furthermore, a user device may be programmed to remove advertisements from storage for interleaving, block specific or certain types of advertisements, or replace the advertisements. Meanwhile the content will still be presented so long as ad value is available to pay for the content.

A number of exemplary implementations and examples have been described. Nevertheless, it will be understood that various modifications may be made. For example, suitable results may be achieved if the steps of described techniques are performed in a different order and/or if components in a described system, architecture, device, or circuit are combined in a different manner and/or replaced or supplemented by other components. Accordingly, the above described examples and implementations are illustrative and other implementations not described are within the scope of the following claims.

What is claimed is:

1. A content provider system to provide content to a user device over a communications path, the system comprising:
an advertising system to provide advertising content from a sponsor;
an ad value system to provide one or more ad values associated with presenting advertising content to a user and which may be redeemed to purchase content;
a processing device to combine the advertising content with the one or more ad values; and
an interface between the processor and the communications path to transmit the combined ad value and advertising content to a user device for presentation to a user.

2. The system of claim 1 wherein the interface is configured to receive a user selection for content having an associated price and to receive a user payment including the one or more ad values accumulated from presentation of associated advertising content to a user to purchase the content indicated by the user selection, and the processor is configured to process the payment for the price and provide the indicated content to the interface for transmission to the user device in response to successfully processing the credit.

3. The system of claim 1 wherein the ad value is digital cash.

4. The system of claim 3 wherein ad value includes an associated time limit after which the ad value expires.

5. The system of claim 1 wherein the processor is configured to combine the ad value to the advertising content as a watermark.

6. The system of claim 1 wherein ad value is specified for a domain and may be redeemed only for content corresponding to the domain.

7. The system of claim 1 wherein the ad value is a general ad value provided to more than one user device.

8. A user device to communicate with one or more content providers over a communications path, the device comprising:
an interface to communicate with the communication path, to receive content from the content provider, and to receive combined advertising content and ad values;
an interleaver to insert the advertising content in the content provider content for presentation to a user; and
an ad value decoder to credit a user with the ad value associated with the inserted advertising content.

9. The user device of claim 8 wherein the content received from the content provider includes one of temporal, spatial, or geometric interleaving cues and the interleaver inserts the advertising content according to the cues.

10. The user device of claim 8 wherein the ad value is digital cash.

11. The user device of claim 8 further comprising a bank to store the credit associated with ad values accumulated from presenting advertising content.

12. The user device of claim 8 further comprising a user interface to select content from the content provider having an associated price, wherein the interface is configured to send the decoded ad values to the content provider commensurate with the price and receive the selected content for presentation to a user.

13. A method of providing content from a content provider to a user device over a communications path, the method comprising:
receiving advertising content from a sponsor;
determining one or more ad values associated with presenting the advertising content to a user that may be redeemed to purchase content or services;
combining the advertising content with the one or more ad values; and
transmitting the combined ad value and advertising content to a user device for presentation to a user.

14. The method of claim 13 further comprising:
receiving a user selection for content or a service having an associated price from the user device;
receiving a user payment from the user device including the one or more ad values accumulated from presentation of associated advertising content to a user to purchase of the content or service indicated by the user selection;
processing the payment for the price; and
providing the indicated content or service to the user device in response to successfully processing the payment.

15. The method of claim 13 wherein transmitting ad value and receiving the user credit includes transmitting and receiving digital cash.

16. The method of claim 13 wherein transmitting the ad value and receiving the user credit includes transmitting a general ad value provided to more than one user device and receiving the general ad value and a user identification.

17. The method of claim 13 wherein combining the ad value with the advertising content further comprises adding the ad value to the advertising content as a digital watermark.

18. The method of claim 13 wherein determining an ad value further comprises determining an ad value specified for a domain that may be redeemed only for content corresponding to the domain.

19. A method for compensating a user for the presentation of advertising content transmitted to a user device over a communications path, the method comprising:
receiving content from the content provider,
receiving combined advertising content and ad values;
inserting the advertising content in the content provider content;
presenting the advertising content to the user; and
crediting a user with the ad value associated with the presented advertising content.

20. The method of claim 19 wherein inserting advertising content including inserting the advertising content according to one of temporal, spatial, or geometric interleaving cues provided in the received content provider content.

21. The method of claim 19 wherein receiving the combined advertising content and ad values includes receiving advertising content embedded with digital cash.

22. The method of claim 19 wherein receiving the combined advertising content and ad values includes receiving advertising content embedded with a general ad value provide to more than one user.

23. The method of claim 19 further comprising storing the credit associated with ad values accumulated from presenting advertising content.

24. The method of claim 19 further comprising selecting a content or service from the content provider having an associated price, transmitting the credited ad values to the content provider commensurate with the price; and receiving the selected content for presentation to a user or providing the service.
